(19) United States
(12) Patent Application Publication
(10) Pub. No.: US 2004/0067340 A1
(43) Pub. Date: Apr. 8, 2004

(54) Car mat

(76) Inventor: Hsueh-Chi Chiang, Taipei City (TW)

Correspondence Address: BIRCH STEWART KOLASCH & BIRCH, PO BOX 747, FALLS CHURCH, VA, 22040-0747, US

(21) Appl. No.: 10/265,574

(22) Filed: Oct. 8, 2002

(51) Int. Cl. B32B 3/00

(52) U.S. Cl. 428/156

(57) ABSTRACT

A car mat includes a vacuum plated sheet which consists of an aluminum foil bonded to a PVC film. The vacuum plated sheet is placed in a car mat press mold for integrally forming a car mat bordered by a protrusive frame and with an indented first upper surface that has bulged bumps formed thereon in a staggered manner. The bulged bumps are spaced from one another by indented grooves.

### FIELD OF THE INVENTION

The present invention relates to a car mat and particularly a versatile car mat for laying on the car carpet to enable people to step thereon without slipping and has a vacuum plated sheet to prevent damping.

### BACKGROUND OF THE INVENTION

The contemporary cars are generally furnished with a high quality and expensive car carpet to make the interior of the cars neat and more appealing. In order to keep the car carpet in good condition without wearing off easily, many car owners place car mats on the car carpet for protection (usually with four car mats in one set for the front seat and the rear seat). Conventional car mats are simply laid on the car carpet. They provide no decorative function and do not have aesthetic effect to the car interior.

Moreover, conventional car mats are formed in a flat surface without moisture-repelling design. External dirt, sands, slops and filthy matters are prone to be carried into the car and onto the car mats through the shoes and boots of the drivers and passengers. These dirt and filthy matters are accumulated and tend to smear the expensive car carpet after a period of time. As a result, the interior of the car could be spoiled.

### SUMMARY OF THE INVENTION

Therefore the primary object of the invention is to resolve the aforesaid disadvantages. The invention provides a vacuum plated sheet formed by bonding an aluminum foil to a PVC film. The vacuum plated sheet is placed in a car mat press mold for forming an integrated car mat that has a protrusive frame on the peripheral rim, an indented top surface, and bulged bumps formed on the top surface in a staggered fashion and spaced by grooves. The car mat thus formed has the top surface covered by the vacuum plated sheet to prevent damping.

Another object of the invention is to provide a car mat for improving car interior appealing and offering anti-damping effect to prevent moisture from seeping into the car carpet.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a PVC film and an aluminum foil of the invention.

FIG. 2 is an exploded view of a vacuum plated sheet and a car mat press mold of the invention.

FIG. 3 is a perspective view of a car mat of the invention.

FIG. 4 is an exploded view of the first embodiment of the invention.

FIG. 5 is a perspective view of the embodiment according to FIG. 4.

FIG. 6 is a top view of the embodiment according to FIG. 4.

FIG. 7 is a perspective view of the second embodiment of the invention, with elongated lump patterns.

FIG. 8 is a top view of the third embodiment of the invention, with rectangular lump patterns.

FIG. 9 is a top view of the fourth embodiment of the invention, with diamond lump patterns.

### DESCRIPTION OF THE PREFERRED EMBODIMENTS

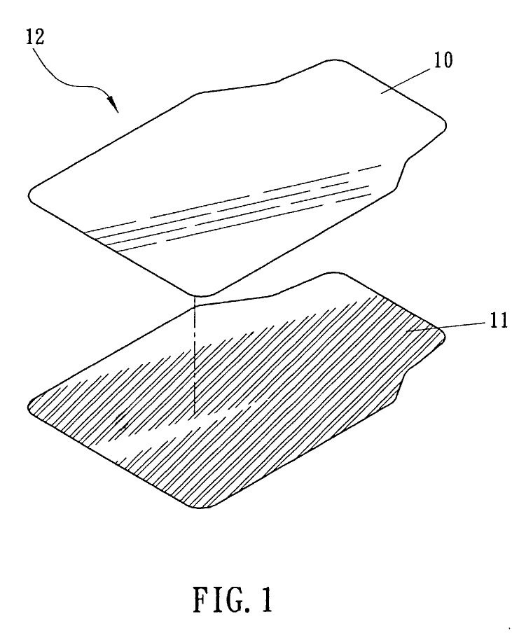

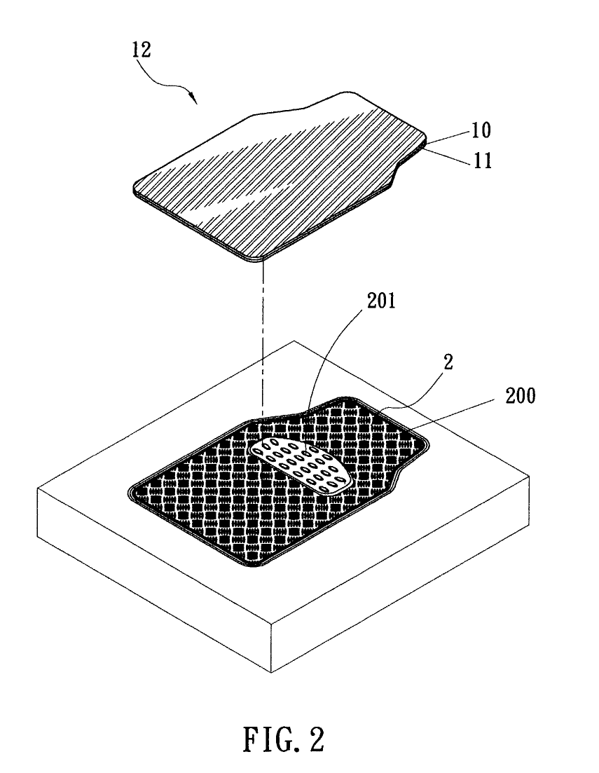

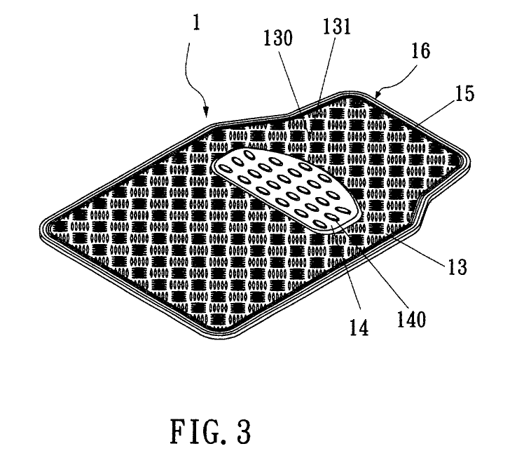

Referring to FIGS. 1 and 2, the car mat 1 of the invention includes of a vacuum plated sheet 12 formed by bonding a PVC film 10 to an aluminum foil 11. The vacuum plated sheet 12 is placed in a car mat press mold 2 to form the integrated car mat 1 through a mold pressing technique (as shown in FIG. 3).

The car mat 1 has an indented first upper surface 13 that has bulged bumps 130 formed thereon in a staggered manner. The bulged bumps 130 are spaced from one another by indented grooves 131. In the center of the car mat there is a second upper surface 14 formed in an elongated manner. The second upper surface 14 has a plurality of bulged lumps 140 formed thereon in an equally spaced manner. The first upper surface 13 is formed on a pad 16 bordered by a protrusive frame 15 on the peripheral rim thereof. The car mat 1 thus formed may withstand treading of people in the car and also fend off moisture. The shape of the car mat may be made according to the front seat and rear seat locations where the car mat to be laid.

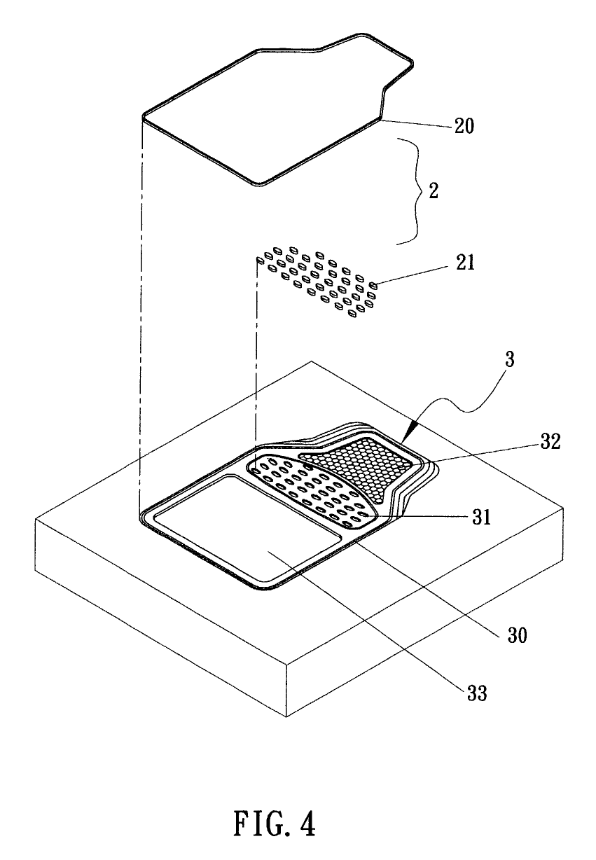

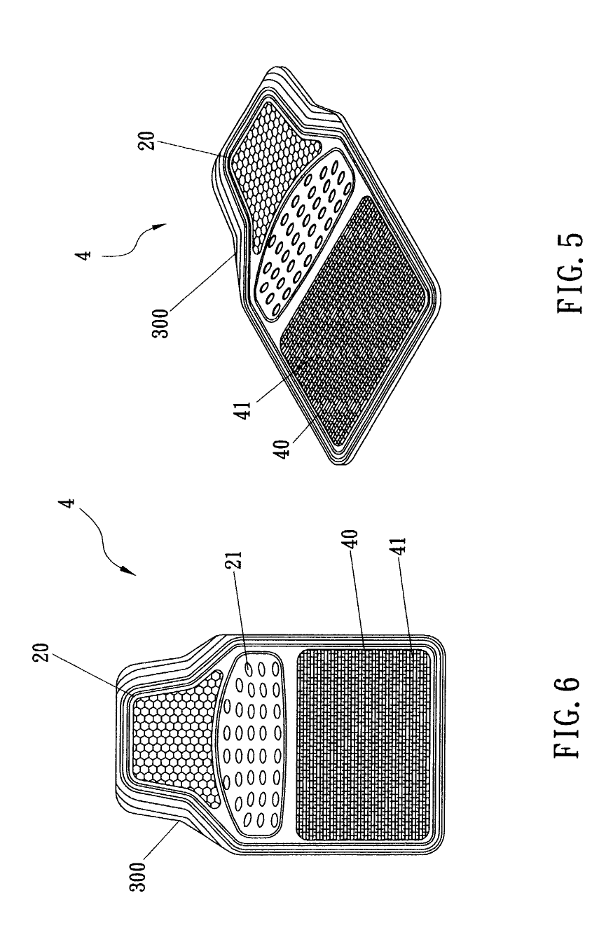

Refer to FIG. 4 for another embodiment of the invention. It is substantially same as the one shown in FIG. 1. The difference is that the PVC film 2 is formed in a protrusive frame 20 of different colors with hollow spaces and bulged lumps 21. The PVC protrusive frame 20 and the bulged lumps 21 are placed in corresponding indented groove 30 and cavities 31 located in the center of a press mold 3 to integrally form a car mat 4 through the mold pressing technique (as shown in FIGS. 5, 6). The car mat 4 thus formed can be made with a desired aesthetic appearance. The PVC protrusive frame 20 and the bulged lumps 21 may be made with different colors to further increase the appeal.

Then the rear end of the car mat 4 may form a third upper surface 40 with a recess for holding a piece of felt 41.

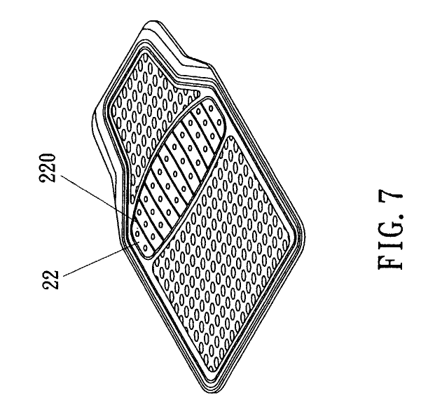

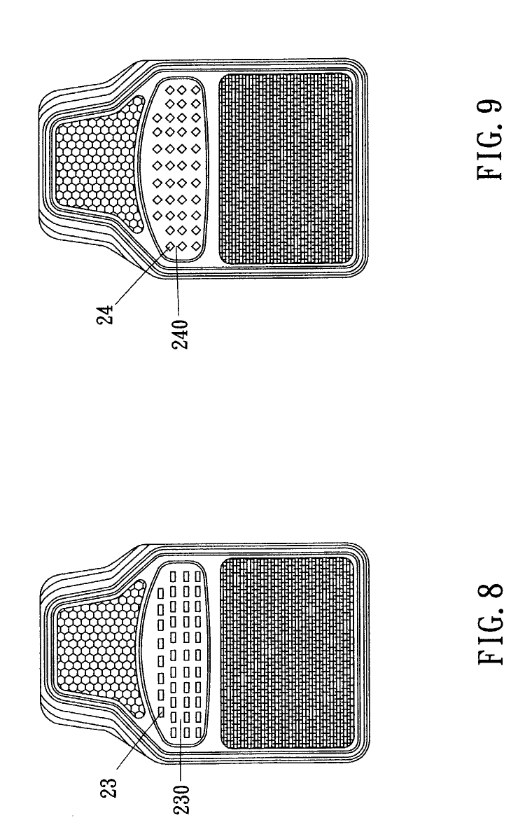

The car mat 3 made according to the method set forth above has a PVC film 2 of different colors with a plurality of bulged lumps 21 located thereon in an equally spaced manner. The bulged lumps 21 may be shaped in elongated blocks 22 (as shown in FIG. 7), rectangular blocks 23 (as shown in FIG. 8), diamond blocks 24 (as shown in FIG. 9) or the like with different colors. The elongated blocks 22, rectangular blocks 23 or diamond blocks 24 are spaced longitudinally and transversely from one another by a plurality of indented grooves 220, 230 or 240. Thus when dirt, sands, slops or other filthy matters are carried into the car by people through shoes or boots, they are scraped off by the elongated blocks 22, rectangular blocks 23 or diamond blocks 24, and are collected in the grooves 220, 230 or 240. And they may be cleared easily by removing and cleaning the car mat. In addition, the car mat is designed with an indented upper surface, it can confine the dirt and filthy objects without spreading outside or smearing the car carpet. The car carpet and the interior of the car may be maintained in a clean and neat condition.

What is claimed is:

1. A car mat comprising a vacuum plated sheet formed by bonding a top PVC film to an aluminum foil located in a middle layer, the vacuum plated sheet being placed in a car mat press mold for integrally forming a car mat through a mold pressing technique; wherein the car mat has an indented first upper surface that has bulged bumps formed thereon in a staggered manner, the bulged bumps being spaced from one another by indented grooves, the car mat further having an elongated second upper surface located in the center thereof, the second upper surface having a plurality of bulged lumps formed thereon in an equally spaced manner, the first upper surface being formed on a pad bordered by a protrusive frame.

2. The car mat of claim 1, wherein the PVC film is formed in a protrusive frame of different colors with hollow spaces and a plurality of bulged lumps, the protrusive frame and the bulged lumps being placed in corresponding indented groove and cavities located in the center of another car mat press mold to integrally form another car mat through the mold pressing technique with a third upper surface located on a rear end thereof to form a recess for holding a piece of felt.

3. The car mat of claim 2, wherein the bulged lumps formed on the PVC film are selectively made in different colors and formed in shapes of elongated blocks, rectangular blocks or diamond blocks.
